(19) United States
(12) Patent Application Publication
(10) Pub. No.: US 2009/0219535 A1
(43) Pub. Date: Sep. 3, 2009

(54) FRUIT AND VEGETABLE QUALITY CONTROL DEVICE

(76) Inventors: Dario Beltrandi, Imola (Bologna) (IT); Bruno Zauli, Imola (Bologna) (IT)

Correspondence Address: BROWDY AND NEIMARK, P.L.L.C.;624 NINTH STREET, NW, SUITE 300, WASHINGTON, DC, 20001-5303, US

(21) Appl. No.: 11/995,055

(22) PCT Filed: Jun. 12, 2006
(86) PCT No.: PCT/EP06/05688

§ 371 Date: Jul. 14, 2008

(30) Foreign Application Priority Data
Jul. 8, 2005 (IT) RE2005A000077

(51) Int. Cl. G01N 21/00

(52) U.S. Cl. 356/432

(57) ABSTRACT

Device for inspecting fruit and vegetable products in general, and fruit in particular, by spectroscopic analysis of refracted light, comprising at least one runway (2) arranged to receive an alignment of fruits from a loose mass of fruits, means (51, 121-122) for advancing said fruits along said runway, and, for laterally illuminating said fruits, means (91) positioned in correspondence with means (92) arranged to collect the refracted light which passes through the fruit, to concentrate it and to feed it to spectroscopic analysis means, at least one portion of the base of the runway being provided with an aperture at which means are provided to collect the refracted light which has passed through the fruit.

### TECHNICAL FIELD

In the preservation and packaging of fruit and vegetables, and of fruit in particular, various product control operations are usually carried out, comprising inter alia weight control, dimensional control, external appearance control, and internal quality control, by means of devices which receive the light transmitted through the inspected fruit and transmit it to spectroscopic analysis means.

### PRIOR ART

Said operations are generally carried out individually on the individual fruits which transit, contained in suitable seats of socket or cup shape, through the various inspection and control stations.

Specifically, for weight control the known devices comprise a conveyor in which individual cups receive the fruit and transit over a suitably calibrated load cell.

In the known art said devices are also generally used for the spectroscopic inspection of the fruit, by providing a suitable station along the path of the cups which receive the fruit.

As the fruits are generally contained loosely in large containers, an organizing operation is generally required upstream of the inspection and control machine to transfer the fruits from the container to the cups of the control device.

Said organizing operation is generally carried out by known devices usually called organizers, which carry out the operations of withdrawing the fruit from the loose mass, spacing the fruits at the distance apart of the cups intended to receive them, and transferring the individual fruits into the individual cups.

As the same inspection and control machine is used both for weight control and for spectroscopic quality control, the state of the art presents a series of drawbacks and difficulties, as follows.

The fruit reception cups suffer from a certain constructional complication deriving from the need to maintain them vertically independent of the conveyor with which they are associated to enable weight control, the need to apply suitable screens to ensure correct fruit illumination without the contaminant effects of ambient light, and by the need to present a central hole to be associated with the devices which capture the light refracted through the fruit.

All said drawbacks arise in particular when an existing weight control machine is to be adapted to also control quality.

In such cases it is almost inevitable to have to replace at least all the cups, the cost of which represents a considerable part of the cost of the entire plant.

Arranging a spectroscopic quality control station within an existing plant is not free of difficulty, because of the need to insert within the existing conveyor path all those devices required to effect said control, which may be of incompatible layout and dimensions.

### DISCLOSURE OF THE INVENTION

An object of the present invention is to remedy said problems within the framework of a simple and economical solution adaptable to existing plants without the need for radical modifications.

Said object is attained according to the invention by associating the spectroscopic control means with the organizer device usually provided upstream of the quality control machine.

The organizer device is a simple and low-cost device compared with the quality control machine, and if not already adapted to receive the spectroscopic control means it can be replaced without an extra cost incompatible with system economy.

A further object of the invention is therefore to provide a simple and economical organizer device able to be associated with spectroscopic control means, and to feed the fruits to a downstream quality control machine.

A last but no less important object of the invention is to provide spectroscopic control means for the fruits which are self-sufficient and independent of the existing lines for controlling the weight and other fruit quality parameters.

All the aforesaid objects are attained by a device having the characteristics defined in the independent claims.

The dependent claims define advantageous characteristics of the invention or possible embodiments thereof.

### BRIEF DESCRIPTION OF THE DRAWINGS

The merits and constructional and operational characteristics of the invention will be more apparent from the ensuing detailed description, illustrated by the figures of the accompanying drawings which relate to two preferred embodiments thereof given by way of non-limiting example.

FIG. 1 is a schematic side view of a first embodiment of the invention, with a detail enlarged.

FIG. 2 shows the section II-II indicated in FIG. 1.

FIG. 3 shows the section III-III indicated in FIG. 1.

FIG. 4 is a plan view of FIG. 1.

FIG. 5 is a section perpendicular to the preceding.

FIG. 6 is a schematic side view of a second embodiment of the invention.

FIG. 7 is the section VII-VII indicated in FIG. 6.

FIG. 8 is the plan view of FIG. 6.

FIG. 9 is the section IX-IX indicated in FIG. 6.

FIG. 10 is the section X-X indicated in FIG. 6.

### BEST MODE FOR CARRYING OUT THE INVENTION

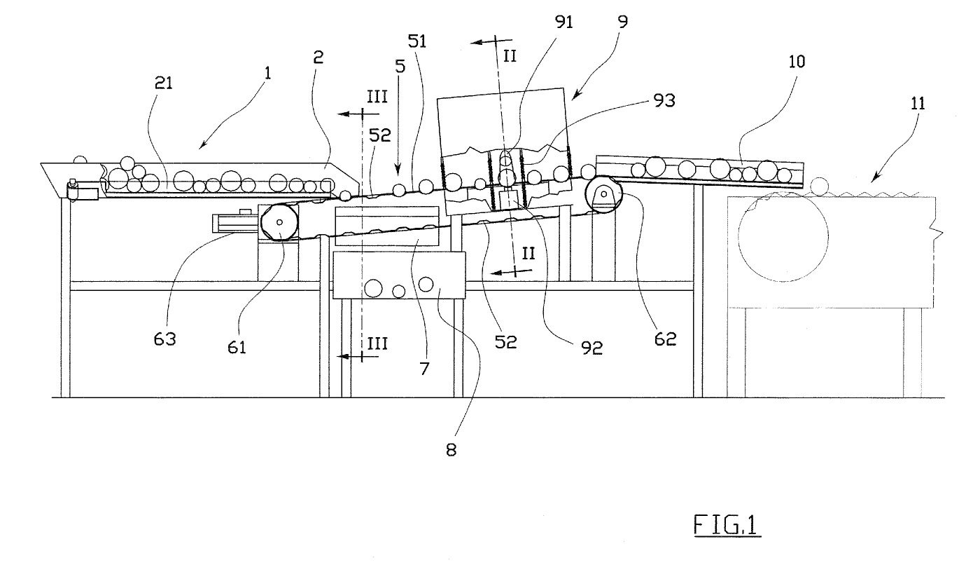

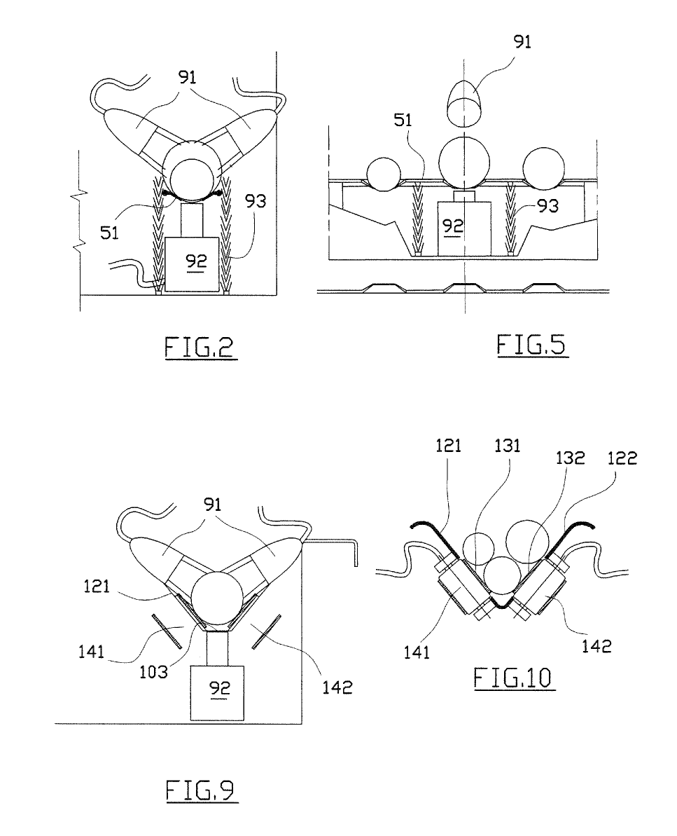

FIGS. 1 to 5 show, from left to right, a profiled bed 1 for receiving loose fruits.

The bed 1 comprises three identical parallel runways 2, only one of which is described hereinafter.

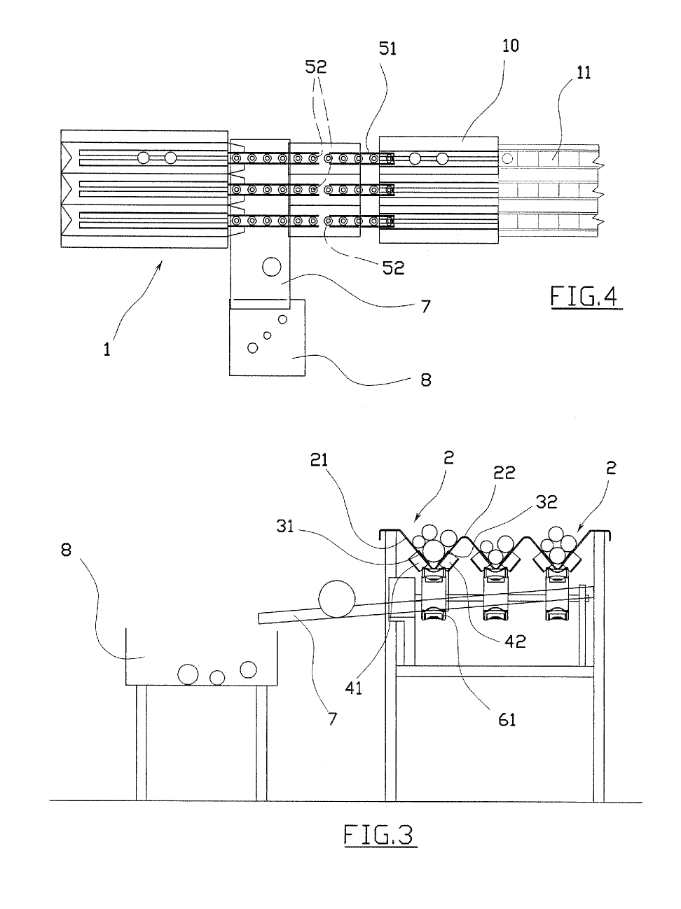

Each runway comprises two sheet metal side walls 21 and 22 formed from a single V-bent strip, at the base of each of which there slides a belt of rubber or other suitable material, 31 and 32 respectively (FIG. 3).

Each belt passes about pairs of end drums 41 and 42 respectively, one drum of each pair being motorized.

The runways climb slightly towards the right in the figure, the belts rotating in the direction to drag the fruits towards the right; the speed of the belts can also be slightly different, to facilitate fruit alignment.

Downstream of the bed 1, in correspondence with each runway 2, a conveyor 5 is positioned to form the base of a fruit track. It comprises a flexible belt 51 in which downwardly open circular seats 52 are formed by deep-drawing.

The belt 51 extends between two drums 61 and 62, of which the upstream drum 61 is motorized by the variable speed gearmotor 63.

Along the path of the belt 51 a chute 7 is positioned, inclined laterally above a container 8.

A unit 9 is positioned downstream of the chute 7, for spectroscopic examination of the fruit.

A slightly descending channel 10 relative to each of the runways 2 is positioned downstream of the conveyor 5, and opens above a conveyor 11 which removes the fruit.

The conveyor 11 can be for example the usual cup conveyor of a weighing line.

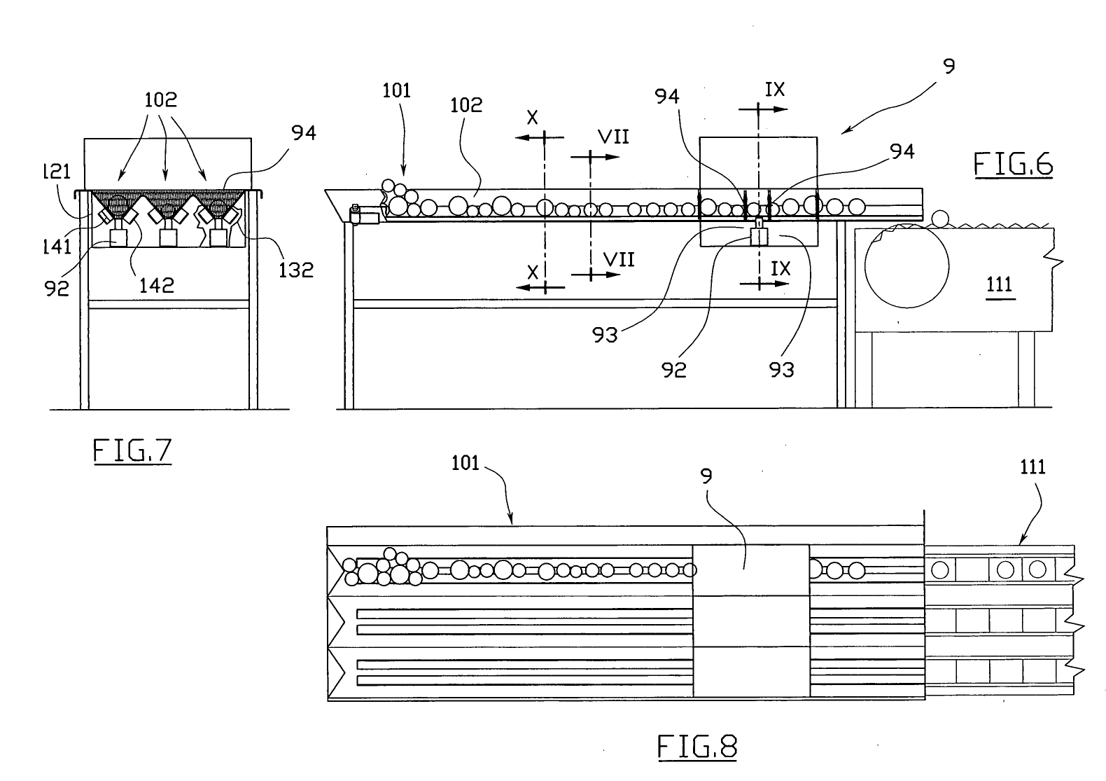

FIGS. 6 to 8 show, from left to right, a profiled bed 101 to receive the loose fruits (FIG. 6).

The bed 101 comprises three identical parallel runways 102, only one of which will be described hereinafter.

Each runway comprises two sheet metal side walls 121 and 122 formed from a single V-bent strip, at the base of each of which there slides a belt of rubber or other suitable material, 131 and 132 respectively.

Each belt passes about pairs of end drums 141 and 142 respectively, one drum of each pair being motorized.

The runways climb slightly towards the right in the figure, the belts rotating in the direction to drag the fruits towards the right.

Each of the runways 102 comprises an interruption 103 in its base, below the belts 131 and 132, in correspondence with a unit 9 for spectroscopic examination of the fruits.

Downstream of the bed 101, for each of the runways 2 a conveyor 111 is positioned to remove the fruits.

The conveyor 111 can be for example the usual cup conveyor of a weighing line.

The device 9 for spectroscopic fruit analysis is of known type, for example of the type described in the European Patent Application published under No. EP 1 215 480 A1.

With regard to the invention, the device 9 (FIGS. 3 and 7) comprises at least one lamp 91 for illuminating the fruit; to prevent the light refracted through the fruit from being contaminated by the direct light of the lamp 91, this is mounted in the following manner.

In the solution of FIG. 1, about the sensor 92 a belt supporting structure is positioned which together with a wall of bristles 93 blocks all the light rays except those which pass through the fruit.

The wall of bristles encloses the sensor on all sides and extends to graze the belt 51.

In the solution of FIG. 4, a wall of bristles 92 is positioned about the sensor 91, and in addition two walls of bristles 94 are positioned in each runway 2 upstream and downstream of the interruption 103, to allow the fruit to pass but prevent light diffusion in the direction of the runways 2.

The device of FIG. 1 operates in the following manner.

The fruits are aligned within the runways 2 which, as stated, climb slightly.

They are dragged by the belts 31 and 32 until they fall onto the conveyor 5. Those fruits which do not settle within the depressions 52 of the belt 51 fall laterally to finish on the chute 7, from which they fall into the bin 8.

The fruits which settle in the depressions 52 pass under the action of the device 9 for spectroscopic analysis, and then abandon the belt 51 aligned in regular succession.

The time required to effect the spectroscopic analysis is very short, of the order of 20 milliseconds.

The operation of the device of FIG. 6 is easily intuitable from the figures.

1. A device for inspecting fruit and vegetable products in general, and fruit in particular, by spectroscopic analysis of refracted light, comprising at least one runway (2) arranged to receive an alignment of fruits from a loose mass of fruits, means (51, 121-122) for advancing said fruits along said runway and, for laterally illuminating said fruits, means (91) positioned in correspondence with means (92) arranged to collect the refracted light which passes through the fruit, to concentrate it and to feed it to spectroscopic analysis means, wherein at least one portion of the base of the runway is provided with an aperture (52, 103) at which means are provided to collect the refracted light which has passed through the fruit, characterized in that said runaway is impermeable to the light except where said fruits are placed during inspection, the light impermeable means (93) being provided to realize an environment closed against the ambient light containing the collecting means of the refracted light.

2. A device as claimed in claim 1, wherein wherein at least one runway comprises light-impermeable means (93) to prevent contamination of the refracted light by the ambient light.

3. A device as claimed in claim 1, wherein at least one runway comprises a movable belt 51 provided with equidistant deep-drawn open-based seats.

4. A device as claimed in claim 1, wherein at least one runway comprises a channel of triangular cross-section with walls (21, 22) converging at the base.

5. A device as claimed in claim 4, wherein the means for advancing the fruits comprise two motorized belts (31, 32, 131, 132) slidable on the walls in proximity to their base.

6. A device as claimed in claim 4, wherein the lower corner of the channel presents an aperture (103) for passage of the refracted light which has passed through the fruit in transit within the channel.

7. A device as claimed in claim 2, wherein the light-impermeable means (93) for preventing contamination of the refracted light by the ambient light consist of a wall (93) of flexible bristles.
